(19) United States
(12) Patent Application Publication
(10) Pub. No.: US 2008/0130563 A1
(43) Pub. Date: Jun. 5, 2008

(54) Communication Terminal and Network Control Device

(76) Inventors: Ming Qiang Xu, Chiba (JP); Sachiko Takeshita, Tokyo (JP); Maki Amishima, Kanagawa (JP); Kentaro Takei, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 11/885,120

(22) PCT Filed: Mar. 13, 2006
(86) PCT No.: PCT/JP06/04921

§ 371 Date: Aug. 27, 2007

(30) Foreign Application Priority Data
Mar. 24, 2005 (JP) 2005-086356

(51) Int. Cl. H04Q 7/20; H04Q 7/38

(52) U.S. Cl. 370/329; 370/351

(57) ABSTRACT

A communication terminal (1) comprises a wireless interface (19) for detecting intensity of radio wave that is received via a plurality of networks that use different communication schemes; a movement prediction unit (14) for predicting a destination network based on radio wave intensity detected by the wireless interface (19); and prediction information transmission unit (13) for transmitting a bandwidth reservation request that requests reservation of a bandwidth between a destination network control device (4) controlling communication connection in a destination network that is predicted to be the destination of the communication terminal and a network control device (3) to which the communication terminal is currently connected as well as transfer of currently communicated communication information to the destination network control device, to the network control device to which the communication terminal is currently connected. This enables smooth switching to a different network.

### TECHNICAL FIELD

The present invention relates to data transmission control when a terminal moves across networks while performing communication.

### BACKGROUND ART

In recent years, there has been an increasing variety of mobile networks such as public mobile networks, hot spots, and PHS networks within companies. When a communication terminal moves across different networks, it is required that the best communication quality for an application is ensured in a destination network and that time required for switching from one network to another is minimized.

A well-known technique for switching between different IP networks is Mobile IP technique developed by Internet Engineering Task Force (IETF). In Mobile IP technique, when a communication terminal moves from one network to another, the terminal obtains a Care of Address (CoA) from a Foreign Agent (FA) for the destination network and registers the obtained address to its Home Agent (HA) that is provided in its home network. Then, the HA sets up a tunnel to the FA and transfers data to the communication terminal through the tunnel.

Japanese Patent Laid-Open No. 2002-325275 discloses a technique for reducing time for which communication is interrupted when a communication terminal moves across networks. This technique is an improvement of Mobile IP technique. The communication terminal described in Japanese Patent Laid-Open No. 2002-325275 is provided with movement prediction means for predicting whether the communication terminal will move across networks. Based on movement prediction information obtained by the movement prediction means, a Foreign Agent (FA) that can be utilized in the destination network is predicted and selected. The communication terminal registers the selected Foreign Agent to its Home Agent in advance and sets a data route before entering the destination network. Thus, time required for setting a data route can be shortened during network switching.

### DISCLOSURE OF THE INVENTION

Although the technique described in Japanese Patent Laid-Open No. 2002-325275 enables data routing in IP layer established during communication, the technique does not consider change in bandwidth in a destination network. The technique does not provide for reservation of bandwidth or change of a codec to be used that are required to realize real-time communication in a destination network with the best communication quality. Consequently, in this technique, a communication terminal needs to perform session negotiation with the other party of communication again in a destination network. For example, in the case of SIP (RFC3261), a communication terminal has to reserve a bandwidth by means of ReInvite after it enters a destination network. Since the technique requires negotiation with the other party after a communication terminal enters a destination network, it takes some time for the communication terminal to receive an application with the best communication quality.

In view of such background, an object of the invention is to provide a communication terminal and a network control device that provide control so that switching to a different network can be made smoothly.

The communication terminal according to the present invention comprises a radio wave intensity detection unit for detecting intensity of radio wave received via a plurality of networks that use different communication schemes; a movement prediction unit for predicting a destination network based on radio wave intensity detected by the radio wave intensity detection unit; and a bandwidth reservation request transmission unit for transmitting, to a network control device to which the communication terminal is currently connected, a bandwidth reservation request that requests reservation of a bandwidth between a destination network control device for controlling communication connection in the network that is predicted to be a destination and the network control device that is currently providing communication connection as well as transfer of communication information currently being communicated to the destination network control device.

By the movement prediction unit predicting a network to which the communication terminal will travel and the bandwidth reservation request transmission unit sending a bandwidth reservation request before the communication terminal enters the destination network, the communication terminal reserves a bandwidth between the network control device for the destination network and the network control device for the current network. This can save time required for reserving a bandwidth between the network control device for the current network and the network control device for the destination network when the communication terminal enters the destination network, thereby allowing smooth switching to a different network. Since communication information currently being communicated is transmitted from the network control device for the current network to the network control device for the destination network through a bandwidth reservation request, the communication terminal does not have to perform negotiation with the other terminal again when it enters the destination network, which can allow smooth switching to a different network.

The communication terminal may comprise a user needs storage unit for storing bandwidths set by a user as the user needs, and the bandwidth reservation request transmission unit may read a bandwidth from the user needs storage unit and transmit a bandwidth reservation request that requests reservation of the bandwidth.

By transmitting a bandwidth reservation request for reserving a bandwidth preset by a user, a bandwidth appropriate for the user needs can be reserved.

In the communication terminal, the user needs storage unit may store the bandwidths in association with an application, and the bandwidth reservation request transmission unit may read out a bandwidth corresponding to an application that is currently executed in communication being performed by the communication terminal and transmit a bandwidth reservation request for requesting reservation of the bandwidth.

By storing bandwidths in relation to applications and transmitting a request for a bandwidth that is required for an application currently being communicated, a bandwidth necessary for the application can be reserved in a destination network.

In the communication terminal, the bandwidth reservation request transmission unit may repetitively transmit a bandwidth reservation request until a bandwidth reservation succeeds.

Repetitive transmission of a bandwidth reservation request can increase chance of successful reservation of a bandwidth in a network in which situation constantly changes.

In the communication terminal, the bandwidth reservation request transmission unit may repetitively transmit a bandwidth reservation request with a bandwidth to be reserved gradually lowered until a bandwidth is successfully reserved.

By transmitting bandwidth reservation requests with a bandwidth to be reserved gradually lowered, chance of successful bandwidth reservation can be increased.

The communication terminal may comprise a user needs storage unit for storing bandwidths set by a user as the user needs, and the bandwidth reservation request transmission unit may repeat bandwidth reservation with a bandwidth gradually lowered within the range of a bandwidth read out from the user needs storage unit.

By gradually lowering a bandwidth to be reserved within the range of a bandwidth preset by a user, chance of successful reservation of a bandwidth within a range that can satisfy the user needs can be increased.

In the communication terminal, after a bandwidth is successfully reserved, the bandwidth reservation request transmission unit may transmit a bandwidth reservation request for reserving a bandwidth higher than the reserved bandwidth.

With this arrangement, the communication terminal can reserve a higher bandwidth while reserving a bandwidth that satisfies minimum requirements.

The communication terminal may comprise a bandwidth release request transmission unit that transmits a bandwidth release request for releasing a bandwidth that is reserved with a bandwidth reserved request transmitted by the bandwidth reservation request transmission unit.

With this arrangement, the communication terminal can release an unused bandwidth to effectively utilize bandwidths in a network.

In the communication terminal, the bandwidth release request transmission unit may transmit the bandwidth release request if the communication terminal has not entered the destination network within a predetermined time after reservation of a bandwidth.

By the communication terminal determining that a reserved bandwidth is not utilized when the communication terminal has not moved to the destination network within a predetermined time after reservation of the bandwidth and releasing the bandwidth, a disadvantage of long-time reservation of an unused bandwidth can be avoided.

In the communication terminal, the bandwidth release request transmission unit may transmit the bandwidth release request when a network that is different from one for which bandwidth is reserved with the bandwidth reservation request is predicted to be the destination.

With this arrangement, a reserved bandwidth is released when a network that is different from one for which bandwidth is reserved is predicted to the destination, so that a disadvantage of redundant bandwidth reservation can be avoided.

The network control device of the present invention is a network control device for controlling communication connection of a communication terminal that is capable of connecting to a plurality of networks that use different communication schemes, comprising a movement prediction information reception unit for receiving, from a communication terminal currently performing communication connection, movement prediction information indicating a destination network that is predicted to be the destination of the communication terminal; a bandwidth reservation control unit for reserving a bandwidth between a destination network device for controlling communication connection in the destination network indicated in the movement prediction information and a network control device for the network in which the communication terminal is currently positioned, before the communication terminal travels to the destination network; and a communication information transmission unit for transmitting communication information currently being communicated to the destination network control device.

The movement prediction information reception unit receives information on the destination network of the communication terminal and a bandwidth with the destination network control device for the destination network is reserved before the communication terminal enters the destination network. This can save time required for reserving a bandwidth between the network control device for the current network and the network control device for the destination network when the communication terminal enters the destination network, which allows smooth switching to a different network. When a bandwidth is successfully reserved, communication information is transmitted to the destination network control device, so that the communication terminal does not have to perform negotiation with the other terminal again when it enters the destination network. Thus, switching to a different network can be made smoothly.

The network control device may comprise a user needs storage unit for storing bandwidths set by a user as the user needs, and the bandwidth reservation control unit may read out a bandwidth corresponding to a communication terminal currently performing communication from the user needs storage unit and reserve the bandwidth.

By storing bandwidths preset by a user, a bandwidth appropriate for the user needs can be reserved.

In the network control device, the user needs storage unit may store the bandwidths in association with applications, and the bandwidth reservation control unit may read out a bandwidth corresponding to an application that is being executed in communication currently performed by the communication terminal from the user needs storage unit and reserve the bandwidth.

By storing bandwidth in relation to applications and reserving a bandwidth required for an application, a bandwidth required for the application can be reserved in the destination network.

In the network control device, the bandwidth reservation control unit may repeat bandwidth reservation until a bandwidth reservation succeeds.

Repetitive bandwidth reservation can increase chance that a bandwidth is reserved in a network in which situation constantly changes.

In the network control device, the bandwidth reservation control unit may repeat bandwidth reservation with a bandwidth to be reserved gradually lowered until a bandwidth reservation succeeds.

By repeating bandwidth reservation with a bandwidth to be reserved gradually lowered, chance of successful bandwidth reservation can be increased.

The network control device may comprise a user needs storage unit for storing bandwidths set by a user as the user needs, and the bandwidth reservation control unit may repeat bandwidth reservation with a bandwidth gradually lowered within the range of a bandwidth read from the user needs storage unit.

By gradually lowering a bandwidth to be reserved within the range of a bandwidth preset by a user, chance of successful reservation of a bandwidth within a range that can satisfy the user needs can be increased.

In the network control device, after a bandwidth is successfully reserved, the bandwidth reservation request transmission unit may transmit a bandwidth reservation request for reserving a bandwidth that is higher than the reserved bandwidth.

With this arrangement, the network control device can reserve a higher bandwidth while reserving a bandwidth that satisfies minimum requirements.

The network control device may comprise a bandwidth releasing unit for releasing a bandwidth reserved by the bandwidth reservation control unit.

With this arrangement, an unused bandwidth can be released so that bandwidths in a network can be effectively utilized.

In the network control device, the bandwidth releasing unit may release a reserved bandwidth when the communication terminal does not travel to the destination network within a predetermined time after reservation of the bandwidth.

The network control device determines that a reserved bandwidth is not used when the communication terminal has not traveled to the destination terminal within a predetermined time after the bandwidth is reserved and releases the bandwidth, so that a disadvantage of long-time reservation of an unused bandwidth can be avoided.

In the network control device, the bandwidth releasing unit may release a reserved bandwidth if it receives movement prediction information from the communication terminal that indicates a network different from the destination network for which a bandwidth is reserved.

With this arrangement, the network control device releases a reserved bandwidth when a network different from one for which a bandwidth is reserved is predicted to be the destination of the communication terminal, so that a disadvantage of redundant bandwidth reservation can be avoided.

The network switching control method of the present invention is a method for controlling network switching among plurality of networks which use different communication schemes by means of a communication terminal, comprising a radio wave intensity detection step of a communication terminal detecting intensity of radio wave received via a plurality of networks that use different communication schemes; a movement prediction step of the communication terminal predicting its destination network based on radio wave intensity detected at the radio wave intensity detection step; and a bandwidth reservation request transmission step of transmitting, to a network control device to which the communication terminal is currently connected, a bandwidth reservation request that requests reservation of a bandwidth between a destination network control device for controlling communication connection in the predicted destination network and the network control device to which the communication device is currently connected as well as transfer of communication information currently being communicated to the destination network control device.

With this arrangement, as with the communication terminal of the invention, it is possible to save time required for reserving a bandwidth between the network control device for a current network and the network control device for the destination network and eliminate the necessity for the communication terminal to again perform negotiation with the other terminal when the communication terminal enters the destination network. Thus, switching to a different network can be made smoothly.

The network switching control method of the present invention is a method for controlling network switching between different networks by means of a network control device that controls communication connection of a communication terminal that is capable of connecting to a plurality of networks that use different communication schemes, comprising: a movement prediction information reception step of receiving movement prediction information from a communication terminal currently performing communication movement prediction information that indicates a destination network that is predicted to be the destination of the communication terminal; a bandwidth reservation step of reserving a bandwidth between the destination network control device that controls communication connection in the destination network indicated in the movement prediction information and the network control device for the network in which the communication terminal is currently positioned, before the communication terminal travels to the destination network; and a communication information transmission step of transmitting communication information currently communicated to the destination network control device.

With this arrangement, as with the network control device of the invention, it is possible to save time required for reserving a bandwidth between the network control device for a current network and the network control device for the destination network and the necessity for communication terminal to again perform negotiation with the other terminal when the communication terminal enters the destination network. Thus, switching to a different network can be made smoothly.

As will be described below, the present invention has other embodiments. The disclosure of the invention is intended to provide only some aspects of the invention and does not intend to limit the scope of the invention.

### BRIEF DESCRIPTION OF THE DRAWINGS

FIG. 1 shows a functional block diagram of a communication terminal according to the first embodiment;

FIG. 2 illustrates user request information according to the first embodiment;

FIG. 3 shows a functional block diagram of a network control device according to the first embodiment;

FIG. 4 shows the configuration of a communication system according to the first embodiment;

FIG. 5 shows the structure of MPEG-FGS according to the first embodiment;

FIG. 6 shows a sequence according to the first embodiment;

FIG. 7A illustrates information sent from the communication terminal to the network control device;

FIG. 7B illustrates information sent from the network control device to the communication terminal;

FIG. 8A shows the structure of a routing table according to the first embodiment;

FIG. 8B shows the structure of a routing table according to the first embodiment;

FIG. 9 shows a sequence according to the first embodiment;

FIG. 10 shows a sequence according to the first embodiment;

FIG. 11A shows a sequence of bandwidth reservation release;

FIG. 11B shows a sequence of bandwidth reservation release;

FIG. 12 shows the structure of a second message for releasing bandwidth reservation;

FIG. 13 shows the configuration of functional blocks of the communication terminal according to the second embodiment;

FIG. 14 shows the structure of information sent by the communication terminal according to the second embodiment;

FIG. 15 shows the configuration of functional blocks of the network control device according to the second embodiment;

FIG. 16 shows a sequence according to the second embodiment;

FIG. 17 shows a sequence according to the second embodiment;

FIG. 18 shows a sequence according to the second embodiment; and

FIG. 19 shows a sequence according to a modification.

### BEST MODE FOR CARRYING OUT THE INVENTION

The present invention will be described in detail below. The following detailed description and accompanying drawings are not intended to limit the invention. The scope of the invention is defined by the appended Claims.

The network control device and the communication terminal according to embodiments of the invention will be described below with reference to drawings.

### First Embodiment

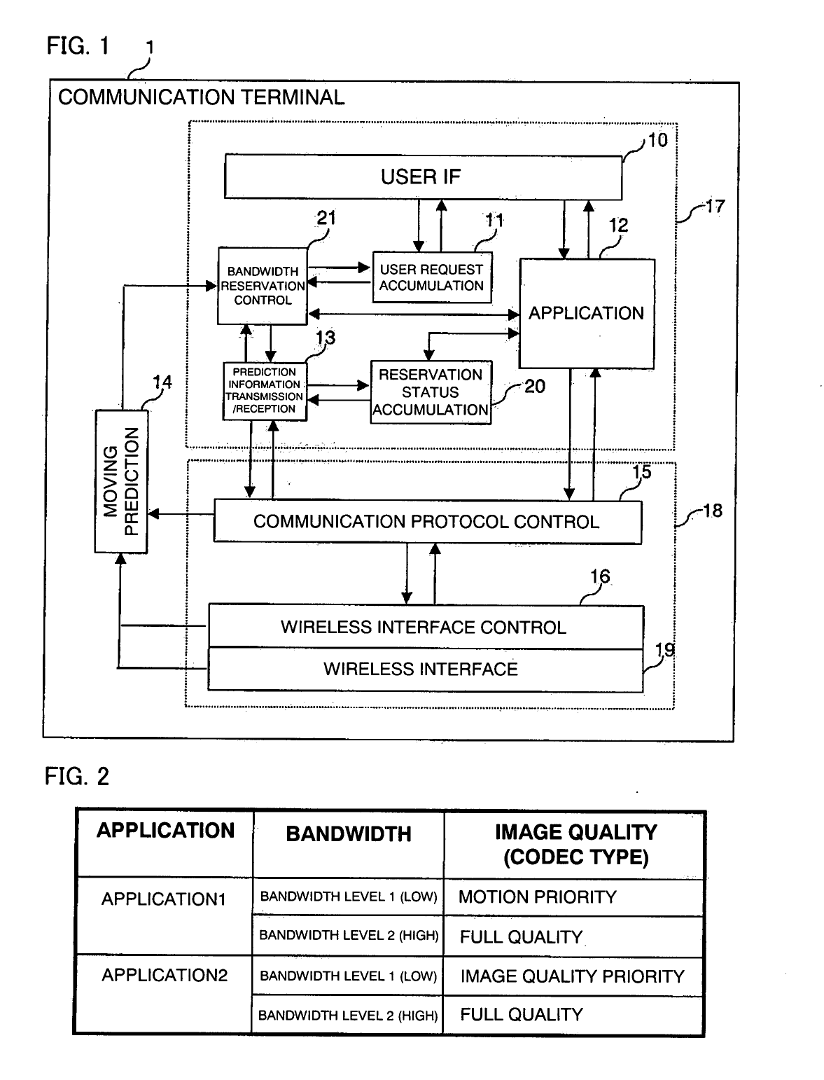

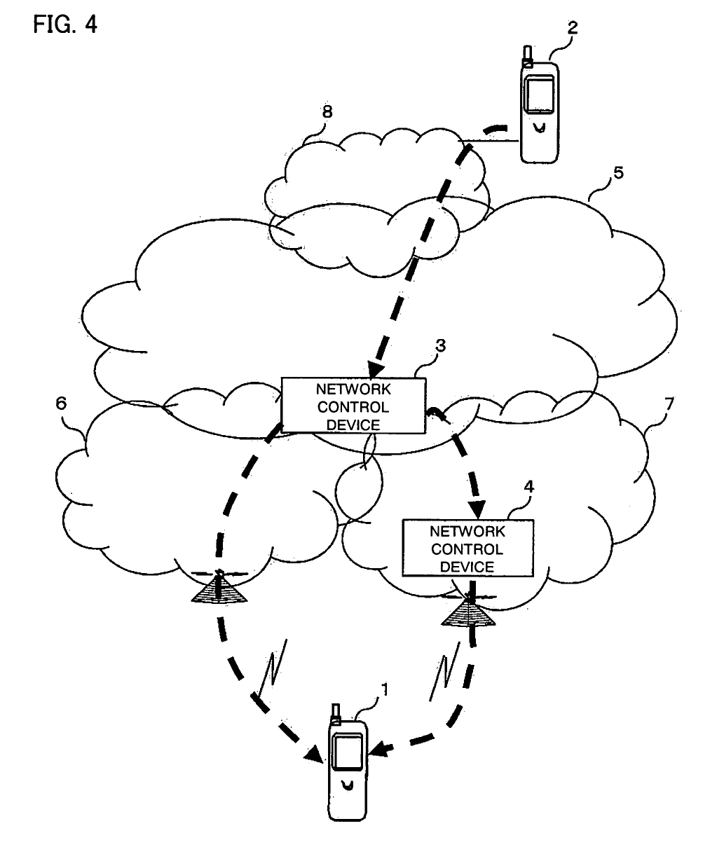

FIG. 1 illustrates the configuration of a communication terminal 1 of the first embodiment and FIG. 3 illustrates a network control device 3 of the first embodiment. Before description using these figures, an environment in which the network control device 3 and the communication terminal 1 according to the first embodiment of the invention are applied will be described.

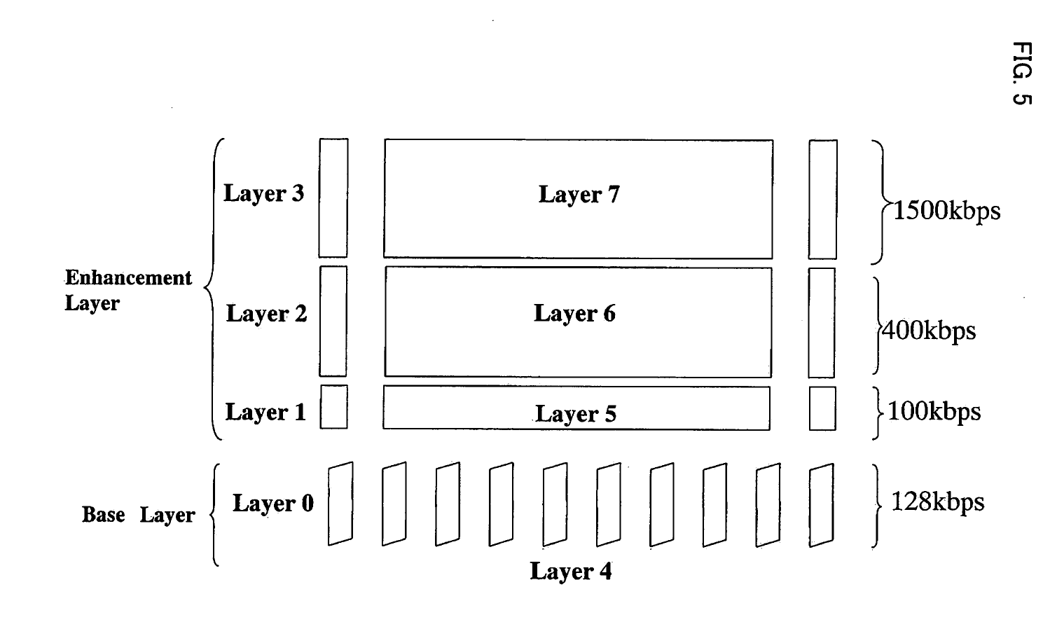

FIG. 4 illustrates the structure of a communication network system representing the environment in which the communication terminal 1 and the network control device 3 according to the first embodiment are applied. The communication terminal 1 and a communication terminal 2 communicate with each other over the Internet 5. A network 6 is the home network for the communication terminal 1. A network 8 is the home network for the communication terminal 2.

Here, encoding method for communication data in the embodiment will be described. In the system shown in FIG. 4, the communication terminals 1 and 2 perform real-time video communication using MPEG-4FGS. MPEG-4FGS is defined in ISO/IEC14496-2 Amendment 4 Streaming Video Profile.

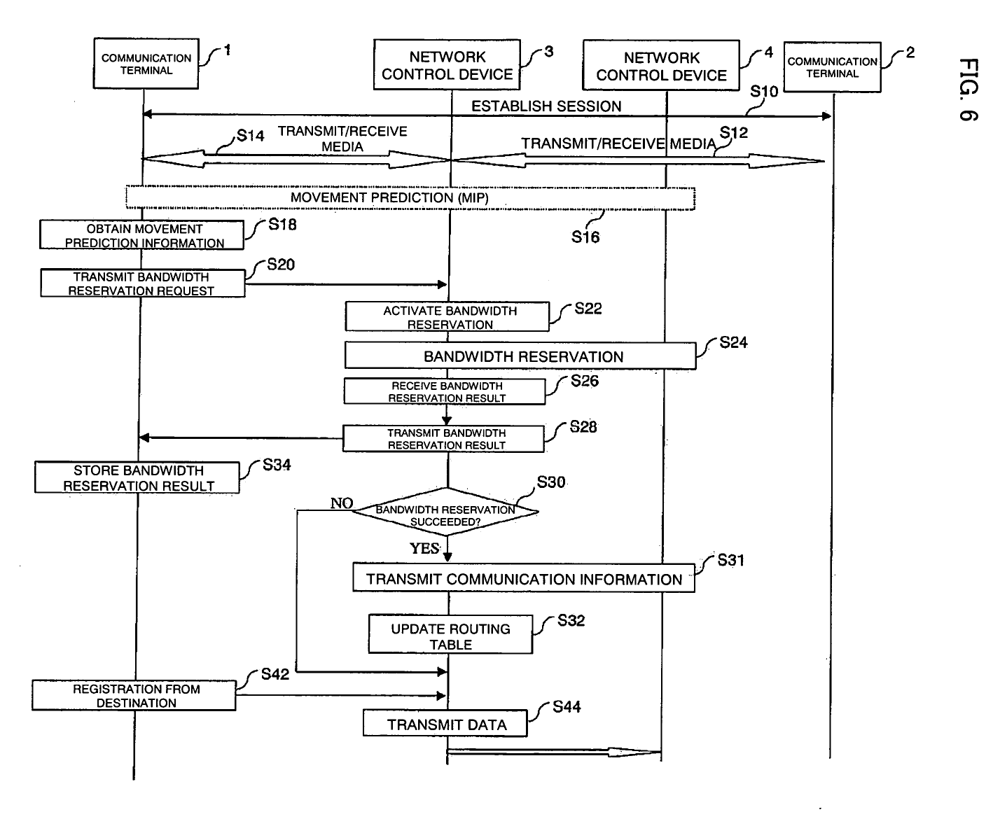

FIG. 5 illustrates Base Layer and Enhancement Layer that constitute motion pictures of FGS. Base Layer is generated with normal MPEG-4 and provides minimum image quality. Meanwhile, Enhancement Layer including layers 1-3 and layers 5-7 provides high-quality motion pictures. Enhancement Layer is decoded through discrete cosine transform and bit plane transform by means of the difference between an image decoded from Base Layer and the original image. Layers 0 and 4 are for prioritizing motion, layers 1 to 3 are for prioritizing image quality, and layers 5 to 7 are for improving image quality for the motion prioritizing layers. A sender separates motion pictures into these layers and encodes them for transmission. A receiver can freely select and decode any of the layers. Transmission from the sender to the receiver is realized by hierarchical multicast. Hierarchical multicast is a technique for realizing multi-rate transmission to each receiver by means of hierarchical encoding. The sender separates outgoing data into layers of Base Layer and Enhancement Layer and transmits the data in multicast. The receiver can group the layers in accordance with a multicast IP address used and select data in necessary layers for reception. The encoding method for data communicated in the embodiment has been thus far described.

The network control devices 3 and 4 are capable of issuing an IP address for the communication terminal 1 and routing data between the communication terminals 1 and 2. The following description will assume a case where the communication terminal 1 travels from an area covered by the network 6 to an area covered by a network 7. When the communication terminal 1 enters the network 7, the network control device 3 transfers data from the communication terminal 2 to the network control device 4, which in turn transmits the transferred data to the communication terminal 1. The network control device 4 transmits data in a codec type which was used in the network 6 for communication between communication terminals 1 and 2.

The communication terminal 1 according to the first embodiment will be described with reference to FIG. 1. As shown in FIG. 1, the communication terminal 1 has a hierarchical structure. An upper layer 17 corresponds to application layer of OSI Reference Model and a lower layer 18 corresponds to transport layer through physical layer of OSI Reference Model. The communication terminal 1 has a movement prediction unit 14 between the upper layer 17 and the lower layer 18 for collecting information from the lower layer 18.

The upper layer 17 of the communication terminal 1 has a user interface 10, a user request accumulation unit 11, an application 12, a prediction information transmission/reception unit 13, a reservation status accumulation unit 20, and a bandwidth reservation control unit 21. The lower layer 18 has a communication protocol control unit 15, a wireless interface control unit 16, and a wireless interface 19. These components of the communication terminal 1 will be described below.

The user interface 10 has function of accepting input from a user and function of outputting information to the user.

The user request accumulation unit 11 stores the type of the application, bandwidth level of a network, and image quality (i.e., Quality of Service) in association with each other.

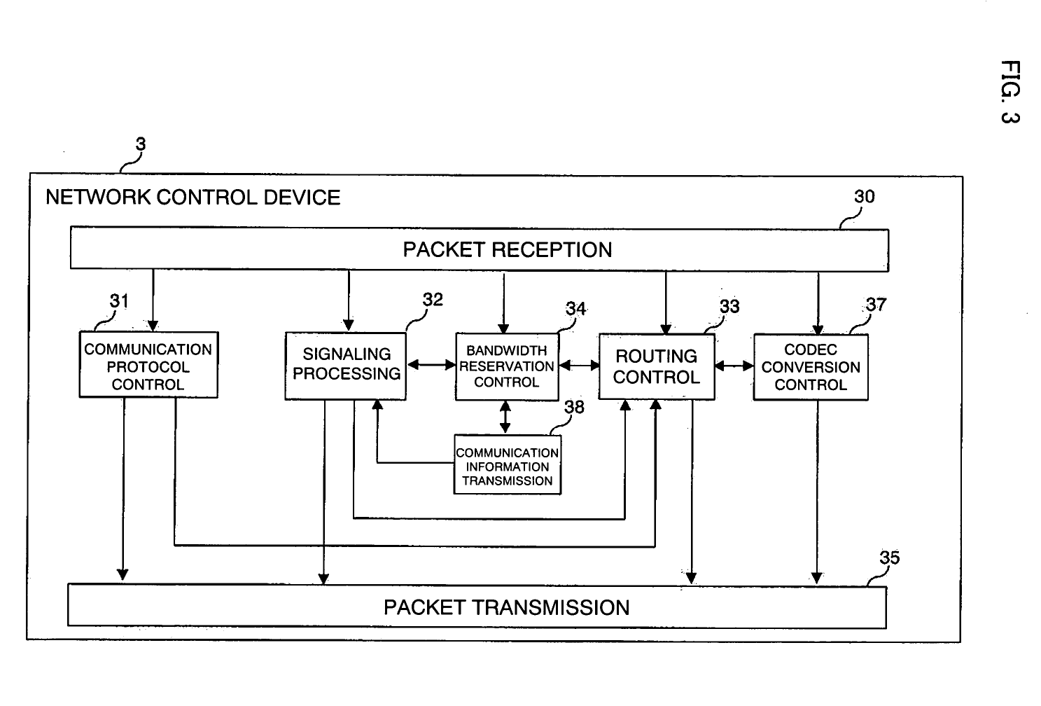

FIG. 2 illustrates an example of user requests accumulated in the user request accumulation unit 11. The user request accumulation unit 11 accumulates image quality (i.e., Quality of Service) in relation to the type of an application utilized and the bandwidth level of the network. User requests for image quality accumulated in the user request accumulation unit 11 are set by the user. For example, when the application is a movie, the user can specify that priority is given to image quality when bandwidth level degrades. When the application is sport, for example, movement of a ball or players is important in general, so that the user can specify that priority is given to movement when bandwidth level degrades.

The application 12 has function of providing conditions and a service logic that are required for a communication service provided to the user.

The movement prediction unit 14 predicts a network to which the communication terminal will travel based on radio wave intensity monitored by the wireless interface 19 and information on packet transmission/reception quality, such as packet loss, that is monitored by the communication protocol control unit 15. For example, by utilizing Mobile IP contained in the communication protocol control unit 15, the movement prediction unit 14 can obtain an IP address for use in the network 7 to which the communication terminal 1 will travel as movement prediction information. The movement prediction unit 14 sends such prediction information to the bandwidth reservation control unit 21.

The prediction information transmission/reception unit 13 has function of transmitting information on movement prediction for the communication terminal 1 to the network control device 3 and function of receiving bandwidth reservation results sent from the network control device 3.

The communication protocol control unit 15 has function of providing control associated with communication protocols at the wireless interface 19. The communication protocol control unit 15 corresponds to transport and network layers of OSI Reference Model.

The wireless interface control unit 16 has function of controlling the wireless interface 19, which is necessary for performing wireless communication. The wireless interface unit 16 corresponds to data link layer of OSI Reference Model.

The wireless interface 19 has function of accessing a wireless access network, corresponding to physical layer of OSI Reference Model. The wireless interface 19 detects radio wave intensity in a plurality of different networks.

The reservation status accumulation unit 20 accumulates bandwidth reservation results received from the network control device 3.

The bandwidth reservation control unit 21 has function of generating a message to be sent to the network control device 3 for reserving a bandwidth and controlling bandwidth reservation. For example, if a bandwidth reservation result received from the network control device 3 does not satisfy a bandwidth that is required for a service currently being utilized, the bandwidth reservation control unit 21 generates a bandwidth reservation request for reserving an appropriate bandwidth based on user requests saved in the user request accumulation unit 11, and sends the request from the prediction information transmission/reception unit 13 to the network control device 3.

The network control device 3 will be described with reference to FIG. 3. The network control device 3, which is capable of controlling data routing, has function of making bandwidth reservation between the network control devices 3 and 4, in addition to data routing function provided by conventional routers and functions defined in a communication protocol. As shown in FIG. 3, the network control device 3 has a packet reception unit 30, a packet transmission unit 35, a communication protocol control unit 31, a signaling processing unit 32, a routing control unit 33, a bandwidth reservation control unit 34, a codec conversion control unit 37, and a communication information transmission unit 38. Each of the components of the network control device 3 will be described below.

The packet reception unit 30 has function of receiving packets and composing a message from the received packets. The packet transmission unit 35 has function of transmitting an outgoing message as packets.

The communication protocol control unit 31 has function of controlling the packet reception unit 30 and packet transmission unit 35. The communication protocol control unit 31 corresponds to transport and network layers of OSI Reference Model.

The signaling processing unit 32 extracts movement prediction information and a request for a bandwidth required for an application from a message received by the packet reception unit 30. The signaling processing unit 32 transmits extracted movement prediction information to the routing control unit 33 and also transmits extracted movement prediction information and bandwidth request to the bandwidth reservation control unit 34.

When the bandwidth reservation control unit 34 receives a notification on movement prediction information and a bandwidth request required for a current application from the signaling processing unit 32, the bandwidth reservation control unit 34 transmits a bandwidth reservation request message for reserving a bandwidth between the network control device 4 for the destination of the communication terminal 1 and network control device 3, to the network control device 4 of the destination network. Upon receiving a bandwidth reservation response, the bandwidth reservation control unit 34 notifies the received bandwidth reservation response to the signaling processing unit 32, routing control unit 33, and communication information transmission unit 38. The bandwidth reservation response comprises success response for indicating successful bandwidth reservation and Failure response for indicating failure to reserve a bandwidth.

The communication information transmission unit 38 transmits communication information for communication that is currently taking place between the communication terminals 1 and 2 to the network control device 4 of the destination network when a bandwidth reservation response received from the bandwidth reservation control unit 34 is a success response.

The routing control unit 33 has function performing routing control for determining where it should transfer data received from the communication terminal 2. The routing control unit 33 of the embodiment adds a new routing path to the routing table according to movement prediction information received from the signaling processing unit 32. For example, when it receives prediction information indicating that the communication terminal 1 will move to the network 7, the routing control unit 33 adds a routing path leading to the network control device 4. The routing control unit 33 puts an added routing path into bandwidth reserved state if a bandwidth reservation response sent from the bandwidth reservation control unit 34 is a success response.

The codec conversion control unit 37 is capable of codec conversion. That is, the codec conversion control unit 37 converts codec type when the codec type of data transmitted from the other party is different from one requested on a routing path.

Operation of the communication terminal 1 and the network control device 3 of the first embodiment having such configurations will be described below.

Referring to FIG. 4, operation of the communication terminal 1 and the network control device 3 will be generally described. Initially, the communication terminal 1 is in the network 6, its home network. When it predicts movement to the network 7, the communication terminal 1 receives an IP address (CoA address) for use in the network 7 before actually moving to the network 7. The communication terminal 1 notifies the IP address and a bandwidth required for an application which is now receiving to the network control device 3. Upon receiving the notification, the network control device 3 starts bandwidth reservation with the network control device 4 in the network 7 to which data is to be transferred.

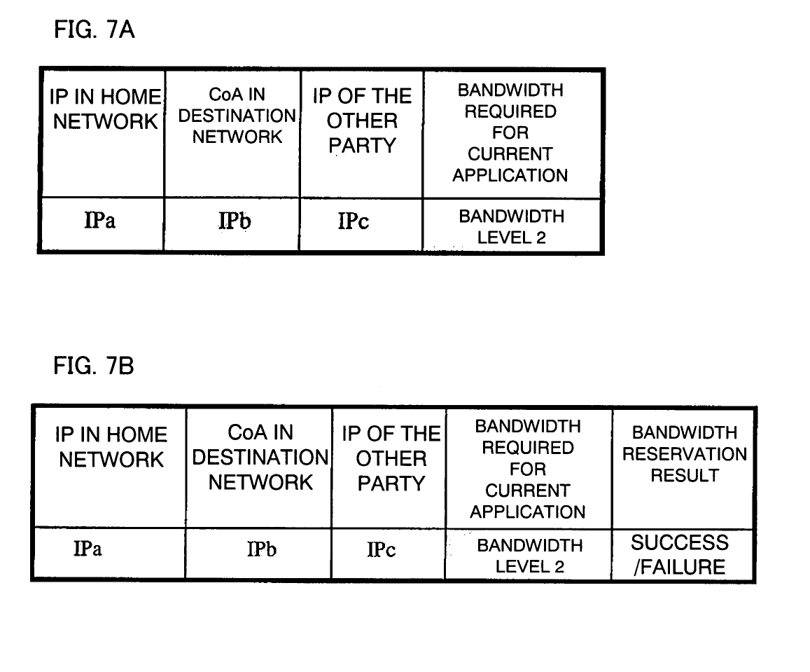

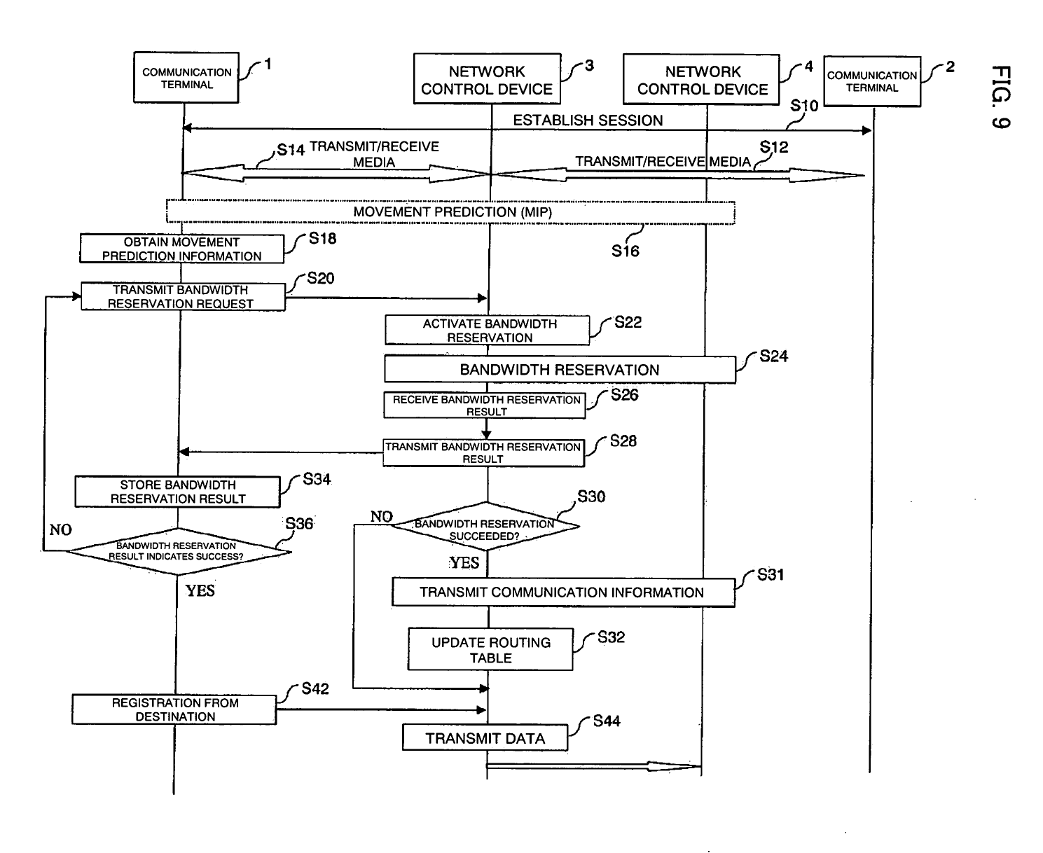

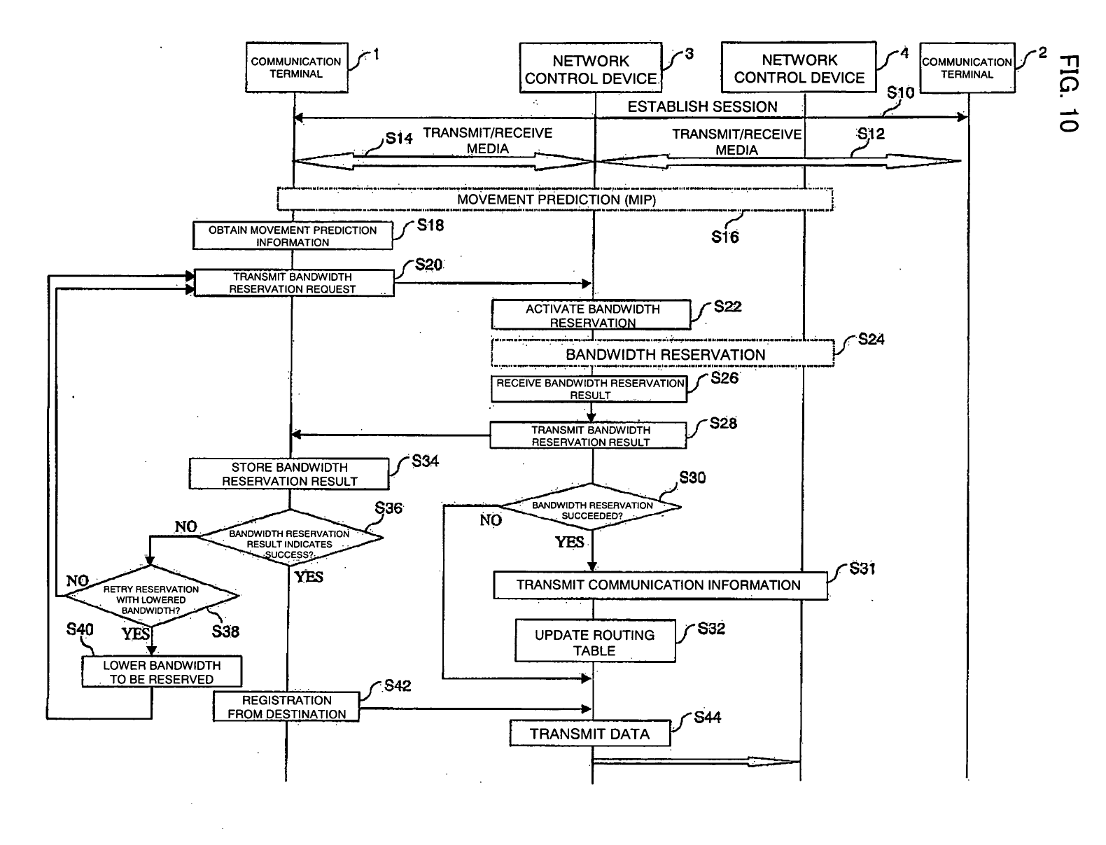

In the following, operation of bandwidth reservation according to the embodiment will be described. FIG. 6 illustrates operation of reserving a bandwidth in the network 7 which is the destination of the communication terminal 1; FIG. 9 illustrates operation of retrying when a bandwidth can not be reserved; and FIG. 10 illustrates operation of retrying with requested bandwidth lowered when a bandwidth can not be reserved. The following discussion will describe operation of each of the aspects shown in FIGS. 6, 9 and 10 in sequence.

Referring to FIG. 6, bandwidth reserving operation will be described. The communication terminals 1 and 2 establish a session for real video communication of full quality for the application 2 at a bandwidth that can be provided by the networks 6 and 8 (S10). Media transmission/reception between the communication terminals 1 and 2 is made by way of the network control device 3 (S12, S14).

When the communication 1 approaches the area for the network 7 from the area for the network 6, the movement prediction unit 14 predicts a network to which the communication terminal 1 will move based on received radio wave intensity and the like. For example, the movement prediction unit 14 can predict information on a CoA (Care of Address) for use in the destination network by utilizing Low Latency Handoffs in Mobile IPv4 (<draft-ietf-mobileip-lowlatency-handoffs-v4-09.txt), which is now under deliberation at IETF. The movement prediction unit 14 of the communication terminal obtained movement prediction information and notify the information to the bandwidth reservation control unit 21 (S16, S18).

Then, the prediction information transmission unit 13 of the communication terminal 1 sends a message for requesting bandwidth reservation to the network control device 3 (S20). The message may be transmitted utilizing Register of SIP, for example. The message transmitted here will be described below.

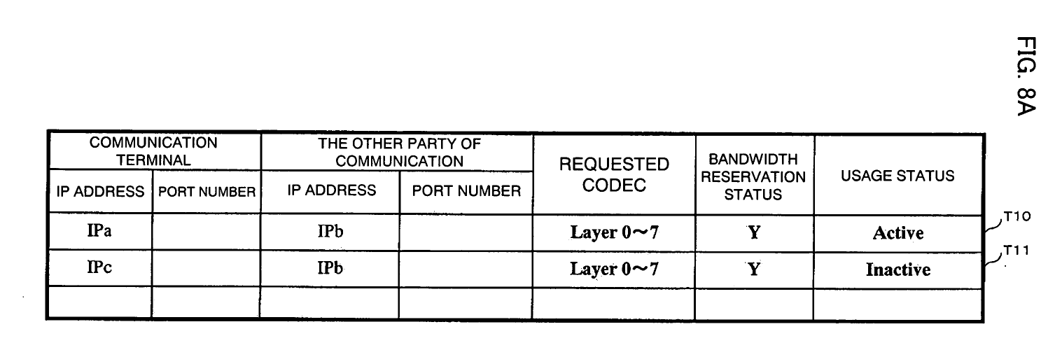

FIG. 7A illustrates contents of a message that is transmitted by the prediction information transmission/reception unit 13 of the communication terminal 1 to the network control device 3 on the communication network. As shown in FIG. 7A, the message sent to the network control device 3 contains the IP address utilized in a network to which the communication terminal 1 is currently accessing, the IP address for use in the destination network, the IP address of the other party, and a bandwidth required for an application currently being used.

When the communication terminal 1 sends such a message for requesting bandwidth reservation to the network control device 3, the signaling processing unit 32 of the network control device 3 extracts movement prediction information and a bandwidth reservation request from the received message. The signaling processing unit 32 notifies the bandwidth reservation control unit 34 about the bandwidth reservation request and activates bandwidth reservation (S22). The bandwidth reservation control unit 34 transmits a message for requesting bandwidth reservation to the network 7, which is predicted to be the destination of the communication terminal 1. The network control device 4 in the network 7 makes bandwidth reservation by a bandwidth reservation protocol such as RSVP (RFC2205), which is defined by IETF, for example (S24).

The bandwidth reservation control unit 34 of the network control device 3 receives a bandwidth reservation result from the network control device 4 (S26). The bandwidth reservation control unit 34 notifies the signaling processing unit 32 about the received bandwidth reservation result. The signaling processing unit 32 of the network control device 3 sends the bandwidth reservation result to the communication terminal 1 (S28). The message indicating a bandwidth reservation result sent here will be described below.

FIG. 7B illustrates a bandwidth reservation result that is sent from the network control device 3 to the prediction information transmission/reception unit 13 of the communication terminal 1. As shown in FIG. 7B, the network control device 3 adds a bandwidth reservation result to the bandwidth reservation request received from the communication terminal 1 and sends it to the communication terminal 1.

The bandwidth reservation control unit 34 of the network control device 3 determines whether the bandwidth reservation result represents a success or a failure (S30). When the bandwidth reservation result is a success, the bandwidth reservation control unit 34 notifies it to the routing control unit 33 and the network control device 3 sends authentication information to the network control device 4. This eliminates the necessity for the network control device 4 to obtain authentication information to the network control device 3 when the communication 1 enters the network 7. The routing control unit 33 adds information for routing to the destination network to the routing table (S32).

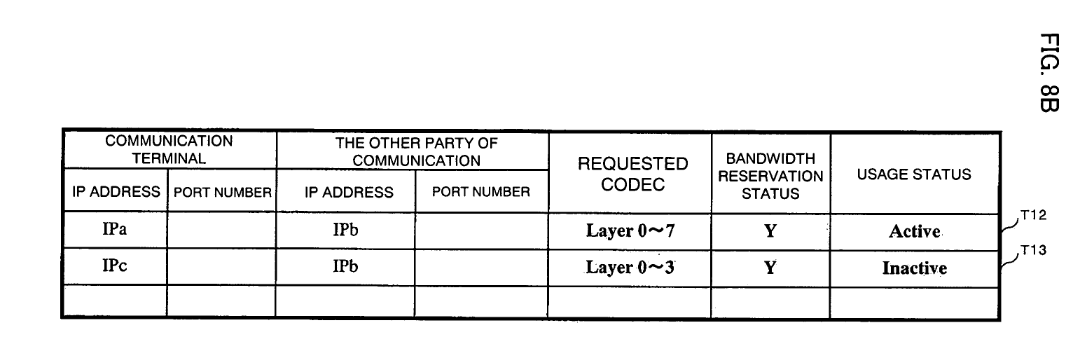

FIG. 8A illustrates a routing table provided in the network control device 3. Row T10 indicates a routing path that is currently used by the communication terminal 1. Row T11 indicates a routing path that has been added when bandwidth reservation with the destination network of the communication terminal 1 succeeded. The codec for the reserved routing path T11 is codec Layer 0 to 7 that corresponds to the routing path T10 which is currently being used. “Y” in bandwidth reservation status means that a bandwidth is reserved. Communication on the reserved routing path T11 starts when registration from the destination network 7 is made. Unless registration is made from the destination network 7, a routing path added to the routing table remains “inactive”.

When it receives a bandwidth reservation result, such as shown in FIG. 7B, from the signaling processing unit 32 of the network control device 3, the reservation information transmission/reception unit 13 of the communication terminal 1 saves the received bandwidth reservation result to the reservation status accumulation unit 20 (S34).

When the communication terminal 1 has entered the destination network 7, the communication terminal 1 makes registration to the network control device (S42). When the protocol control unit 31 of the network control device 3 receives registration from the communication terminal 1, it notifies the IP addresses and port numbers of the communication terminal 1 and the other party of the communication, i.e., the communication terminal 2, to the routing control unit 33, and the routing control unit 33 looks for a routing path from the routing table. When it finds a routing path, the routing control unit 33 transmits data from the other party to the communication terminal 1 on the routing path (S44). Here, see FIG. 8A as an example. Since there is a path IPb→IPc from the communication terminal 2 to the communication terminal 1 (T11), usage status of the path is changed from “inactive” to “active” and data is transferred on the routing path. However, if a routing path is not found, the routing control unit 33 sets the transfer address of the routing path that leads from the communication terminal 2 to the communication terminal 1 in the original network 6 to the IP address of the communication terminal 1 used in the destination network, and routes data from the other party.

Referring to FIG. 9, operation performed when bandwidth reservation by the network control device 3 fails will be described. Operations from reception of movement prediction information from the communication terminal 1 up to bandwidth reservation by the network control device 3 (S10 to S28) are the same as those described with FIG. 6. After the network control device 3 transmits a bandwidth reservation result to the communication terminal 1, the communication terminal 1 determines whether the bandwidth reservation result indicates a success or failure (S36). If the determination shows that bandwidth reservation was a failure, the prediction information transmission/reception unit 13 of the communication terminal 1 retransmits a request for bandwidth reservation to the network control device 3 (NO at S36). Such repetitive transmission of bandwidth reservation requests increases chance that bandwidth is reserved in the network 7 in which congestion condition changes frequently.

Another aspect of operation that is performed when bandwidth reservation by the network control device 3 has failed will be described below with reference to FIG. 10. Operation from reception of movement prediction information from the communication terminal 1 up to bandwidth reservation by the network control device 3 (S10 to S28) are the same as those described above with FIG. 6.

After the network control device 3 sends a bandwidth reservation result (see FIG. 7B) to the communication terminal 1, the communication terminal 1 saves the bandwidth reservation result to the reservation status accumulation unit 20 and also notifies the result to the bandwidth reservation control unit 21. The bandwidth reservation control unit 21 determines whether the bandwidth reservation result indicates a success or a failure (S36). If the bandwidth reservation result is a failure (No at S36), the bandwidth reservation control unit 21 reads out information in the user request accumulation unit 11 to determine whether or not the user needs can be satisfied with a bandwidth lower than the bandwidth which was failed to be reserved (S38). If there is no lower level bandwidth that can satisfy the user needs (NO at S38), the bandwidth reservation control unit 21 makes reservation of a bandwidth of the same level as the failed bandwidth again. However, if there is a lower level bandwidth that can satisfy the user needs (YES at S38), the bandwidth reservation control unit 21 lowers bandwidth level (S40), and retransmits a bandwidth reservation request (S20).

For example, if bandwidth level in the original network 6 is “2”, the bandwidth reservation control unit 21 sends a bandwidth reservation request for bandwidth level “2” also in the destination network 7, and, if the bandwidth reservation fails, it performs operations as follows. The bandwidth reservation control unit 21 reads the user needs from the user request accumulation unit 11. If bandwidth level required by the user is “2”, bandwidth level cannot be lowered any more, so that the bandwidth reservation control unit 21 retransmits a bandwidth reservation request for “2”. When bandwidth level required by the user is “1”, the bandwidth reservation control unit 21 retransmits a bandwidth reservation request with the bandwidth level to be reserved lowered one level, that is, bandwidth level “1”.

FIG. 8B shows a routing table corresponding to this. Row T12 is the same as row T10. Row T13 is a routing path that has been added at retry with level 1 after bandwidth reservation for level 2 failed. The codec for the added routing path is Layer 0 to 3 that corresponds to level 1.

The communication terminal 1 registers itself to the network control device 3 before entering the destination network (S42). After receiving the registration from the communication terminal, the communication protocol control unit 31 of the network control device 3 sends IP addresses and port numbers of the communication terminal 1 and the other party to the routing control unit 33, which then looks for a routing path in the routing table based on the IP addresses and port numbers. Since there is a path IPb→IPc from the communication terminal 2 to the communication terminal 1 in the example shown in FIG. 8B (T13), the usage status of the path is changed from “inactive” to “active” and data is transferred on the routing path. The codec change control unit 37 changes Layer 0-7 codec from the other party to Layers 0-3 according to the routing path and transmits data to the communication terminal 1 (S44).

With these operations, bandwidth resource in the destination network 6 can be effectively utilized in accordance with users' needs.

Release of a reserved bandwidth will be now described. If the communication terminal 1 does not enter the destination network for which a bandwidth is reserved, it is necessary to release the reserved bandwidth. This is because to keep a bandwidth reservation that is not likely to be used is not desirable in order to effectively utilize bandwidth resource. In this embodiment, two methods for releasing reserved bandwidth, one using a timer and one that utilizes notification from the communication terminal 1, will be described.

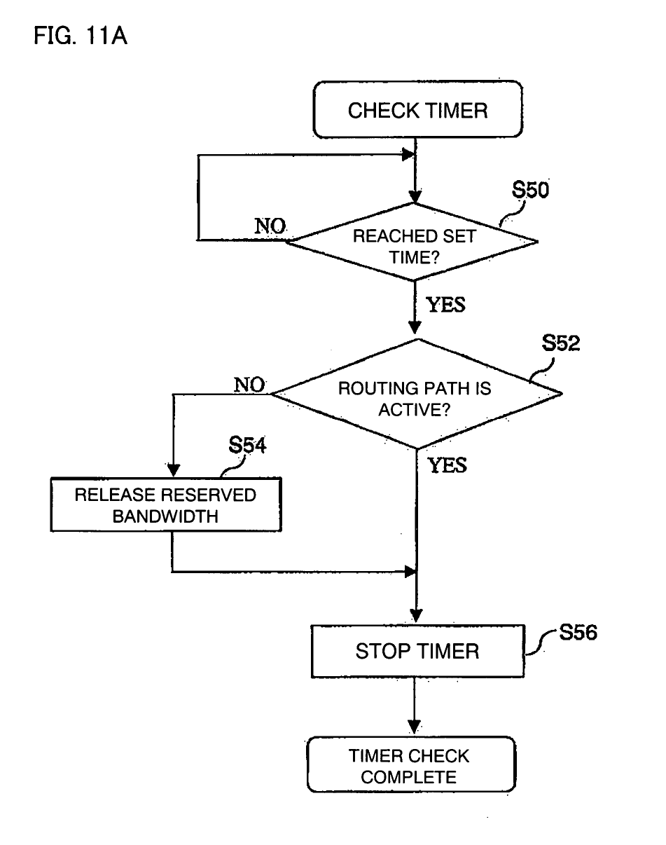

FIG. 11A illustrates release of a reserved bandwidth by means of a timer. When this method is employed, the network control device 3 has a timer in the bandwidth reservation control unit 34. The timer of the bandwidth reservation control unit 34 is activated and starts counting when a result of successful bandwidth reservation is received. When registration from the destination network 7 is received, the timer is stopped. The bandwidth reservation control unit 34 determines whether the counting of the timer has reached a predetermined time (S50). When the counting of the time has reached a predetermined time, it is determined whether the reserved routing path is “active” or not (S52). If the path is not “active”, a message for releasing the reserved bandwidth is sent to release the reserved bandwidth (S54), and the timer is stopped (S56). However, if the path is “active”, the timer is stopped without releasing the bandwidth (S56).

The timer for releasing reserved bandwidth may also be provided in the network control device 4 in the destination network 7 for the communication terminal 1 instead of the network control device 3.

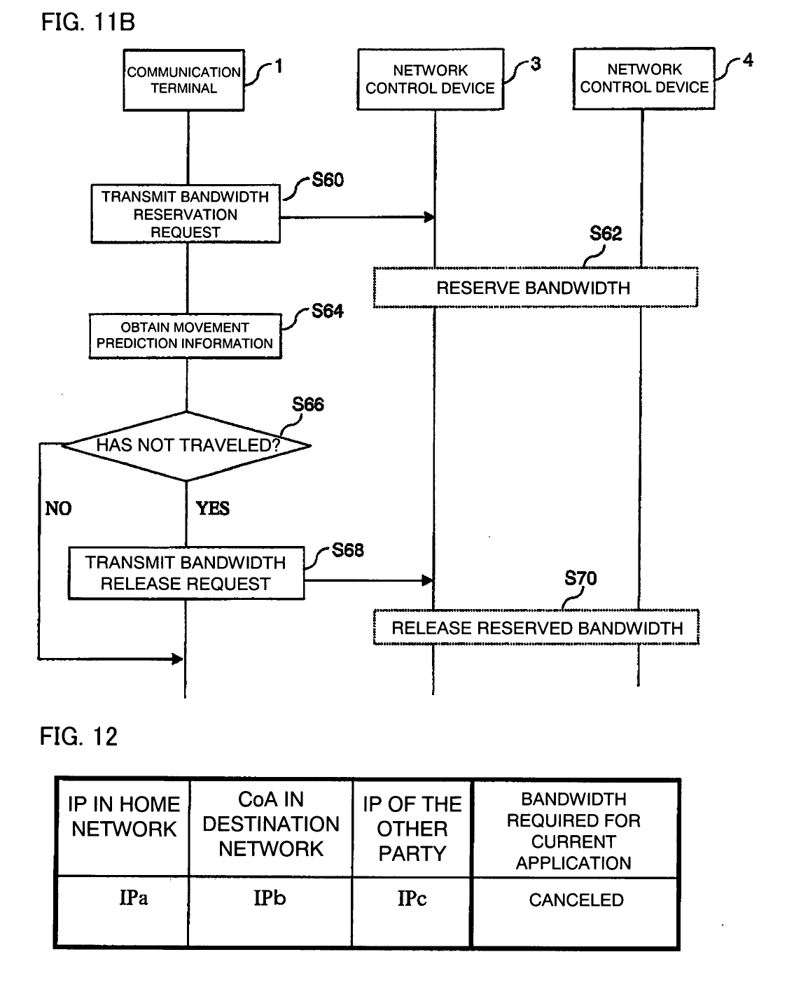

Release of a reserved bandwidth utilizing notification from the communication terminal 1 will be described below. FIG. 11B illustrates a procedure of releasing a reserved bandwidth by means of notification from the communication terminal 1. As described above with FIG. 6, the communication terminal 1 transmits a bandwidth reservation request based on movement prediction information to the network control device 3 (S60). After receiving the bandwidth reservation request, the network control device 3 makes bandwidth reservation (S62). After transmitting the bandwidth reservation request, the communication terminal 1 monitors movement of the communication terminal 1 with the movement prediction unit 14 (S64). The communication terminal 1 determines whether it has not moved to the predicted network 7, that is, whether it will use the original network or another network, based on movement prediction information (S66). If it is determined that the communication terminal 1 has not moved (YES at S66), the communication terminal 1 sends a message for releasing a reserved bandwidth, such as one shown in FIG. 12, to the network control device 3 (S68). Here, the message may be transmitted utilizing Register method of SIP. Upon receiving the releasing message, the network control device 3 releases the bandwidth reserved by the bandwidth reservation control unit 34 of the network control device 3 (S70). When processing of bandwidth reservation is in progress, the bandwidth reservation control unit 34 stops the processing. The network control device 3 routes data utilizing the network which the communication terminal 1 is currently accessing.

Thus, the communication terminal 1 and the network control device 3 according to the first embodiment of the invention have been described.

Since the network control device 3 of the embodiment receives movement prediction information from the communication terminal 1 and reserves bandwidth to the network 7, which is predicted to be destination of the communication terminal 1, communication can be continued when the communication terminal 1 actually enters the network 7 without requiring time for reserving a network bandwidth, which can realize smooth switching of networks.

Since the communication terminal 1 transmits communication information currently being communicated to the destination network control device 4 before entering the destination network 7, the communication terminal 1 can continue communication when it actually enters the network 7 without performing session negotiation with the other party i.e., the communication terminal 2, which thereby realizes smooth switching between networks.

When the network control device 3 fails to reserve bandwidth, it can retry bandwidth reservation, so that chance of reserving bandwidth can be increased. By lowering bandwidth level to be reserved at the retry, chance of successful bandwidth reservation can be further increased.

### Second Embodiment

The communication terminal 1, network control device 3 and data controlling method according to the second embodiment of the invention will be described below. The communication terminal 1 and the network control device 3 of the second embodiment are applied to the same communication network system as in the first embodiment (see FIG. 4).

In the second embodiment of the invention, a user request about relationship between application quality and bandwidth is transmitted from the communication terminal 1 to the network control device 3. The network control device 3 accumulates user requests and makes bandwidth reservation based on user requests.

In the following, the configuration and operation of the communication terminal 1 and the network control device 3 according to the second embodiment of the invention will be described with reference to three examples of operation as in the first embodiment.

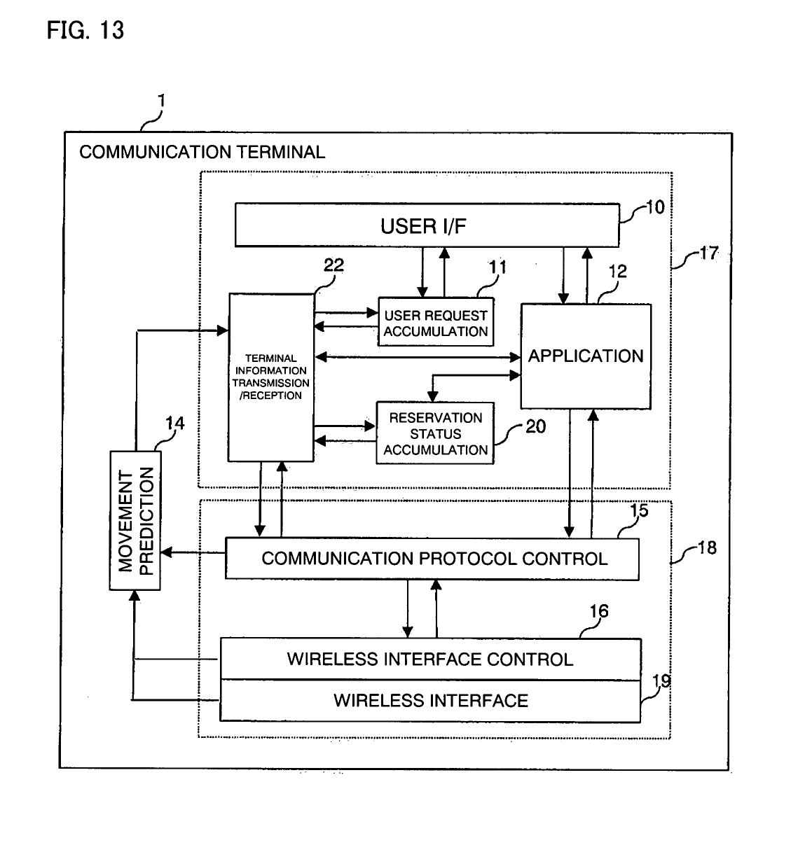

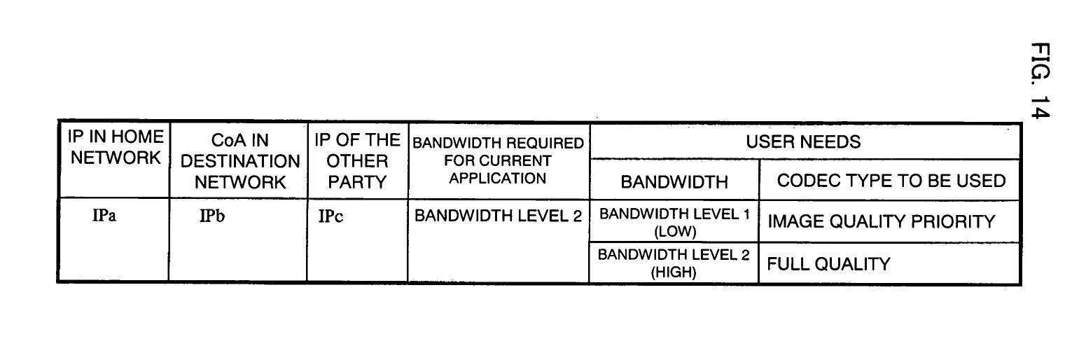

FIG. 13 illustrates the configuration of the communication terminal 1 of the second embodiment. The communication terminal 1 of the second embodiment has basically the same configuration as the communication terminal 1 of the first embodiment. The communication terminal 1 of the second embodiment is different from that of the first embodiment in that it has a terminal information transmission/reception unit 22 in place of the bandwidth reservation control unit 21 and the prediction information transmission/reception unit 13. The terminal information transmission/reception unit 22 sends a message, such as shown in FIG. 14 that contains movement prediction information from the movement prediction unit 14, a bandwidth request required for an application currently being utilized, and a user request stored in the user request accumulation unit 11, to the network control device 3.

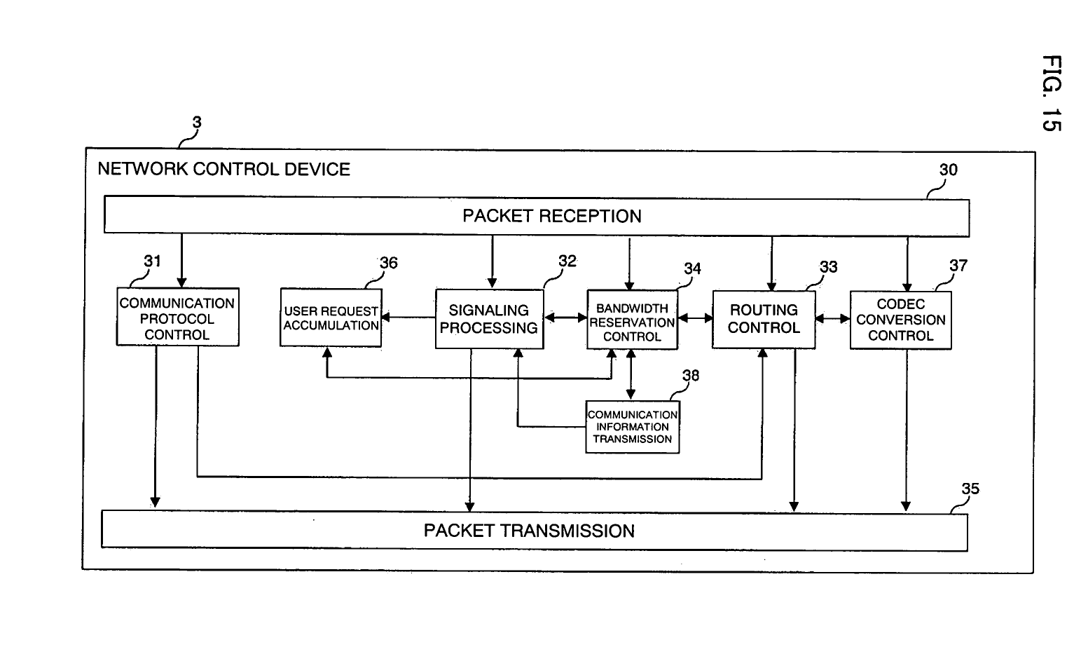

FIG. 15 illustrates the configuration of the network control device 3 of the second embodiment. The network control device 3 of the second embodiment has basically the same configuration as the network control device 3 of the first embodiment, except that it further has a user request accumulation unit 36. The user request accumulation unit 36 accumulates user request information extracted from messages sent from the communication terminal 1.

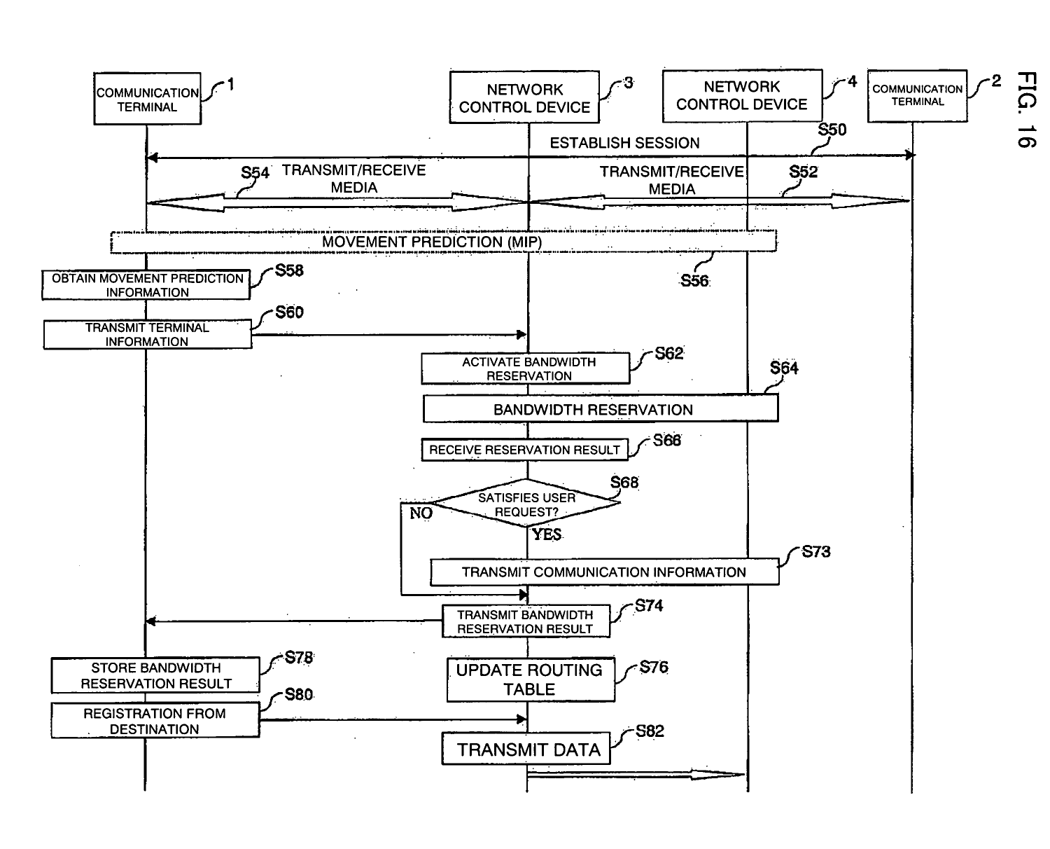

FIG. 16 is a flowchart showing bandwidth reserving operation by the communication terminal 1 and the network control device 3. As shown in FIG. 16, operations of the communication terminal 1 and network control device 3 of the second embodiment are basically the same as the first embodiment, but contents of the message sent from the communication terminal 1 to the network control device 3 at step S60 is different. The message sent from the communication terminal 1 to the network control device 3 contains information indicating the user request in addition to movement prediction information and a bandwidth required for an application currently being communicated. For example, in case a movie is received, a codec corresponding to full quality is added as a user request when bandwidth level is high, and a codec corresponding to image quality priority is added as a user request when bandwidth level is low, as shown in FIG. 14.

After the bandwidth reservation control unit 34 of the network control device 3 makes bandwidth reservation (S62, S64) and receives a bandwidth reservation result (S66), the bandwidth reservation control unit 34 determines whether the received bandwidth reservation result satisfies the bandwidth reservation request (S68). If the received bandwidth reservation result satisfies the bandwidth reservation request (YES at S68), the bandwidth reservation control unit 34 notifies it to the routing control unit 33 and the network control device 3 sends authentication information to the network control device 4 (S73). Then, the network control device 3 sends a bandwidth reservation result which indicates either a success or a failure to the communication terminal 1 from the signaling processing unit 32 (S74).

If the bandwidth reservation result satisfies the bandwidth reservation request, the network control device 3 notifies it to the routing control unit 33 from the bandwidth reservation control unit 34, and the routing control unit 33 adds routing utilization information for the destination of the communication terminal 1 to the routing table (S76).

After receiving a bandwidth reservation result such as shown in FIG. 7B from the signaling processing unit 32 of the network control device 3, the reservation information transmission/reception unit 13 of the communication terminal 1 saves the bandwidth reservation result to the reservation status accumulation unit 20 (S78).

The communication terminal 1 registers with the network control device 3 before entering the destination network 7 (S80). After receiving registration from the communication terminal 1, the communication protocol control unit 31 of the network control device 3 sends IP addresses and port numbers of the communication terminal 1 and the other party to the routing control unit 33. The routing control unit looks for a routing path from the routing table according to the IP addresses and port numbers. The network control device 3 sends data from the other party on the routing path found (S82).

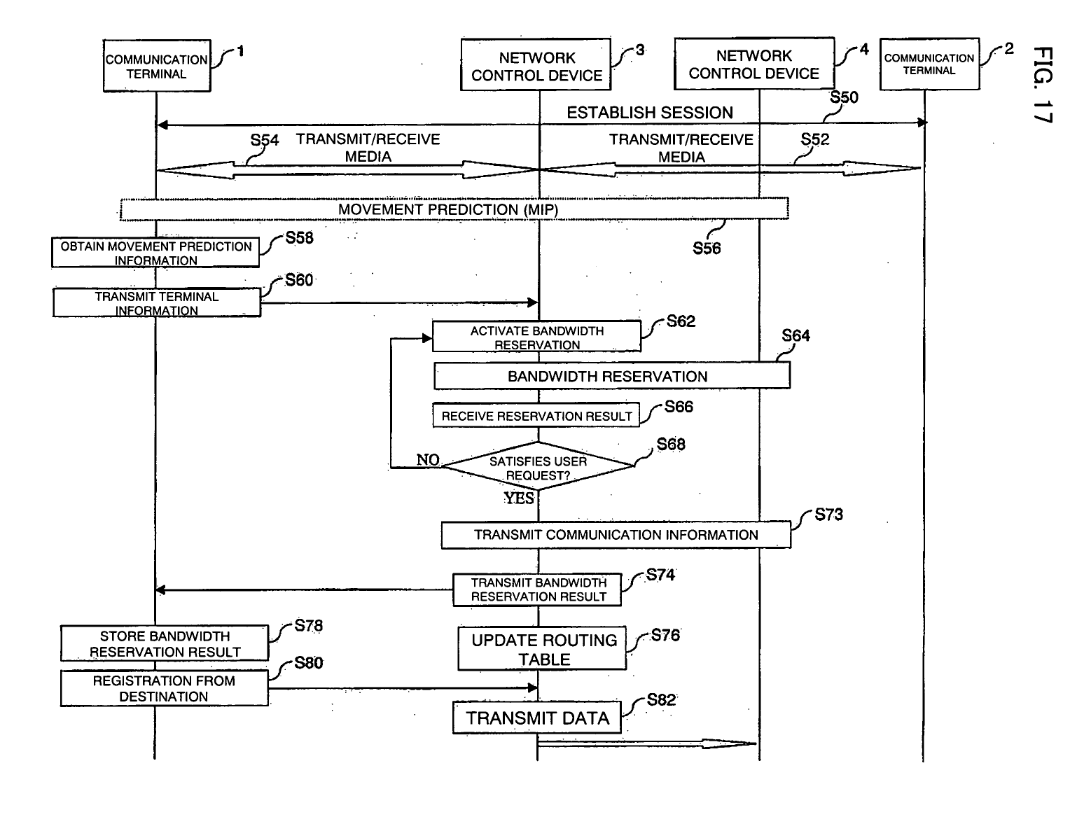

FIG. 17 is a sequence diagram showing operations of the communication terminal 1 and the network control device 3 in which the network control device 3 retries bandwidth reservation when bandwidth reservation failed. Operations from reception of terminal information from the communication terminal 1 up to bandwidth reservation by the network control device 3 (S50 to S66) are the same as those described above with FIG. 16.

After the bandwidth reservation control unit 34 of the network control device 3 makes bandwidth reservation (S62, S64) and receives a bandwidth reservation result (S66), the bandwidth reservation control unit 34 determines whether the received bandwidth reservation result satisfies the bandwidth reservation request (S68). When the bandwidth reservation request is not satisfied, the network control device 3 activates bandwidth reservation and repeats bandwidth reservation (S62). The network control device 3 performs this operation until bandwidth reservation succeeds or bandwidth reservation is canceled by the communication terminal 1.

These operations can increase chance that the network control device 3 reserves bandwidth in a network in which situation frequently changes.

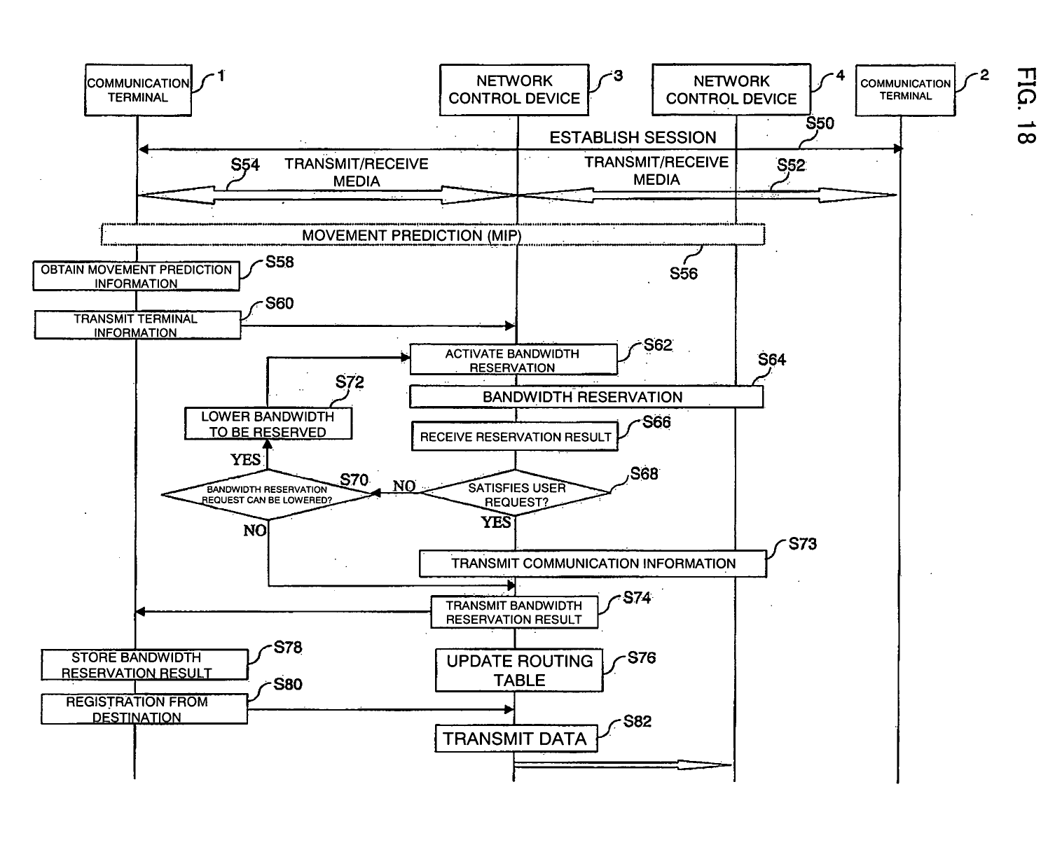

FIG. 18 is a sequence diagram showing operations of the communication terminal 1 and the network control device 3 in which the network control device 3 retires bandwidth reservation with a bandwidth request lowered based on accumulated user requests if a bandwidth reservation fails.

Operations from reception of terminal information from the communication terminal 1 up to bandwidth reservation by the network control device 3 (S50 to S66) are the same as those described above with FIG. 16.

After the bandwidth reservation control unit 34 of the network control device 3 makes bandwidth reservation (S62, S64) and receives a bandwidth reservation result (S66), the network control device 3 determines whether the received bandwidth reservation result satisfies the bandwidth reservation request (S68). If the result does not satisfy the bandwidth reservation request (NO at S68), the network control device 3 obtains the user request from the user request accumulation unit 36 and determines whether it can reserve bandwidth with a lowered bandwidth reservation request within the user request (S70). If the user request can be satisfied with a bandwidth one level lower than the bandwidth for which reservation failed, the network control device 3 retries bandwidth reservation with one level lower bandwidth (S72). For example, if a bandwidth level corresponding to full quality cannot be reserved in the destination network 7, the network control device 3 activates a bandwidth reservation protocol at bandwidth level 1, which is a bandwidth level one level lower, and makes reservation at the lower bandwidth level 1. If it cannot obtain a bandwidth corresponding to the user request, the network control device 3 sends a result of failed reservation to the communication terminal 1 (S74).

If it could reserve bandwidth that satisfies the user request (YES at S68), the bandwidth reservation control unit 34 notifies it to the routing control unit 33 and sends authentication information from the network control device 3 to the network control device 4 (S73). Then, the network control device 3 sends a result of successful bandwidth reservation to the communication terminal 1 by way of the signaling processing unit 32 (S74). The bandwidth reservation control unit 34 of the network control device 3 notifies the routing control unit 33 about the success of bandwidth reservation, and the routing control unit 33 adds routing utilization information for the destination of the communication terminal 1 to the routing table.

As with the first embodiment, the second embodiment reserves a bandwidth to the network control device 4 in the network 7, which is predicted to be the destination of the communication terminal 1, and transmits communication information currently being communicated to the network control device 4 of the destination network 7, so that switching of networks can be smoothly made when the communication terminal 1 actually enters the destination network 7.

Since, in the second embodiment, a user request is transmitted to the network control device 3 along with movement prediction information from the communication terminal 1, and the network control device 3 makes bandwidth reservation based on the user request, the steps taken between the communication terminal 1 and the network control device 3 can be reduced.

The bandwidth releasing unit described above in the first embodiment of the invention can also be applied to the second embodiment.

While the communication terminal and the network control device of the present invention have been described in detail with reference to the embodiments, the present invention is not limited to the embodiments described above.

The above described embodiments referred to an example where, after bandwidth reservation succeeds, the reserved bandwidth is maintained until the communication terminal 1 enters the destination network and the bandwidth is released when a predetermined time has elapsed. However, control for reserving a wider bandwidth may be performed after bandwidth reservation succeeds.

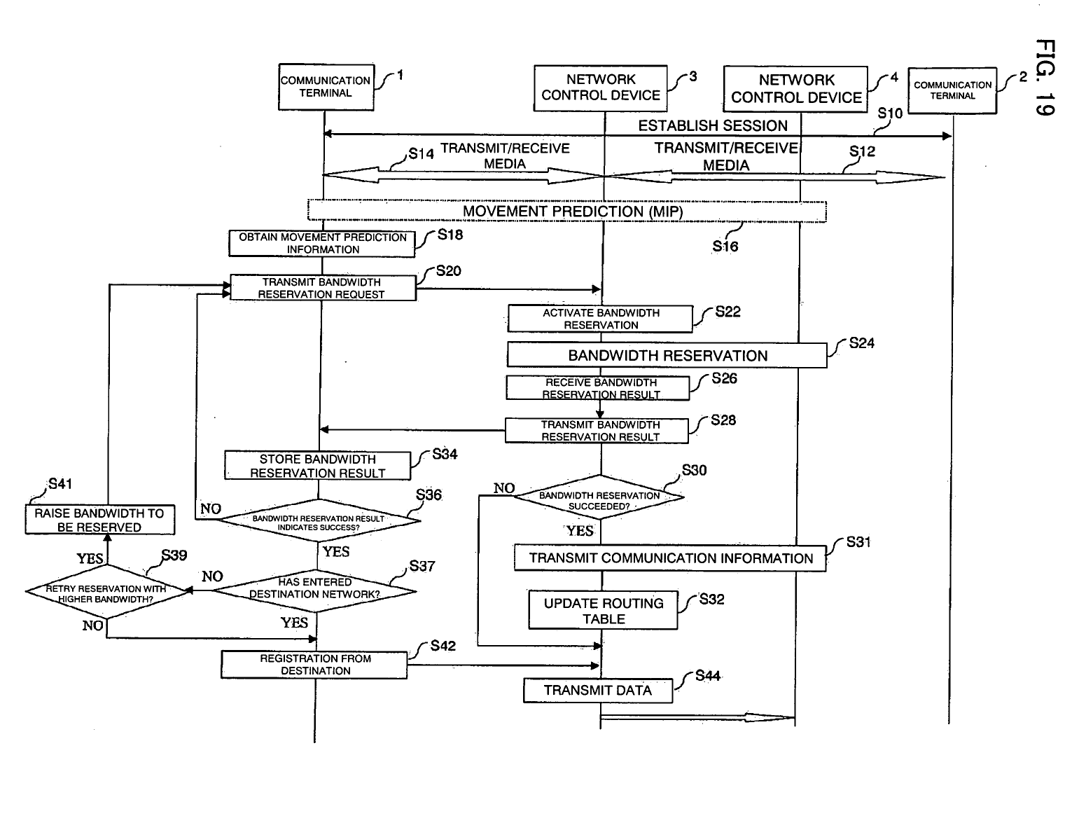

FIG. 19 illustrates operation of requesting a wider bandwidth after successful bandwidth reservation in an example similar to the first embodiment, in which the communication terminal 1 controls bandwidth reservation. The communication terminal 1 and the network control devices 3 and 4 perform basically the same operations as in the flow shown in FIG. 10. In the flow shown in FIG. 19, based on determination of whether a bandwidth reservation result is a success or a failure (S36), if it is determined that the bandwidth reservation is a success (YES at S36), it is determined whether the communication terminal 1 has entered the destination network or not (S37). If it is determined that the communication terminal 1 has not entered the destination network (NO at S37), it is determined whether the communication terminal 1 should retry reservation with a bandwidth higher than the reserved bandwidth (S39). If it is determined that the communication terminal 1 should retry with a higher bandwidth (YES at S39), the communication terminal 1 raises a bandwidth to be reserved (S41), and again makes bandwidth reservation (S20).

In this manner, if the communication terminal 1 does not enter the destination network soon after bandwidth reservation succeeds, the communication terminal 1 requests reservation of a bandwidth higher than the reserved bandwidth. This enables the communication terminal 1 to reserve a higher bandwidth while reserving a bandwidth that satisfies minimum requirements.

Although the above described embodiments referred to security information as an example of authentication information that is transmitted from the network control device 3 to the network control device 4, authentication information is not limited to information on security. Authentication information may be information on codec, for example.

Although the above described embodiments referred to an example where the user request accumulation unit 11 stores a user needs in association with applications, a user needs may not necessarily be stored being associated with applications. The user request accumulation unit 11 may store user needs in association with communication parties, or may not associate user needs with other information. Although the communication terminal moves across IP networks in the above described embodiments, the present invention is applicable to moving across heterogeneous networks.

While the embodiments of the invention which are presently considered to be preferable have been described, it is to be understood that various modifications are possible for the embodiments. It is contemplated that such modifications falling within the true spirit and scope of the invention are all encompassed by the appended Claim.

### INDUSTRIAL APPLICABILITY

As has been thus described, the present invention provides an excellent effect of smooth switching to a different network and may be advantageous for data transmission control for when a communication terminal moves between different networks while performing communication.

1-20. (canceled)

21. A communication terminal, comprising:
a radio wave intensity detection unit for detecting intensity of radio wave received via a plurality of networks that use different communication schemes;
a movement prediction unit for predicting a destination network based on radio wave intensity detected by the radio wave intensity detection unit; and
a bandwidth reservation request transmission unit for transmitting, to a network control device to which the communication terminal is currently connected, a bandwidth reservation request that requests reservation of a bandwidth between a destination network control device for controlling communication connection in a network that is predicted to be the destination network and a network control device to which the communication terminal is currently connected, as well as transfer of currently communicated communication information to the destination network control device;
wherein the bandwidth reservation request transmission unit repetitively transmits a bandwidth reservation request with a bandwidth to be reserved gradually lowered until a bandwidth reservation succeeds.

22. The communication terminal according to claim 21, comprising a user needs storage unit that stores therein bandwidths set by a user as the user needs,
wherein the bandwidth reservation request transmission unit repetitively makes bandwidth reservation with a bandwidth gradually lowered within the range of a bandwidth read out from the user needs storage unit.

23. A communication terminal, comprising:
a radio wave intensity detection unit for detecting intensity of radio wave received via a plurality of networks that use different communication schemes;
a movement prediction unit for predicting a destination network based on radio wave intensity detected by the radio wave intensity detection unit; and
a bandwidth reservation request transmission unit for transmitting, to a network control device to which the communication terminal is currently connected, a bandwidth reservation request that requests reservation of a bandwidth between a destination network control device for controlling communication connection in a network that is predicted to be the destination network and a network control device to which the communication terminal is currently connected, as well as transfer of currently communicated communication information to the destination network control device;
wherein the bandwidth reservation request transmission unit transmits a bandwidth reservation request for reserving a bandwidth higher than the reserved bandwidth after reservation of a bandwidth succeeds.

24. A network control device for controlling communication connection of a communication terminal that is capable of connecting to a plurality of networks that use different communication schemes, comprising:
a movement prediction information reception unit for receiving movement prediction information that indicates a destination network that is predicted to be the destination of the communication terminal currently performing communication, from the communication terminal;
a bandwidth reservation control unit for reserving a bandwidth between a destination network control device that controls communication connection in the destination network indicated in the movement prediction information and the network control device for the network in which the communication terminal is currently positioned, before the communication terminal moves to the destination network; and
a communication information transmission unit for transmitting currently communicated communication information to the destination network control device;
a user needs storage unit for storing bandwidth set by a user as the user needs in association with applications,
wherein the bandwidth reservation control unit reads out a bandwidth corresponding to an application that is currently being executed in communication currently performed by the communication terminal from the user needs storage unit and reserves the bandwidth.

25. A network control device for controlling communication connection of a communication terminal that is capable of connecting to a plurality of networks that use different communication schemes, comprising:
a movement prediction information reception unit for receiving movement prediction information that indicates a destination network that is predicted to be the destination of the communication terminal currently performing communication, from the communication terminal;
a bandwidth reservation control unit for reserving a bandwidth between a destination network control device that controls communication connection in the destination network indicated in the movement prediction information and the network control device for the network in which the communication terminal is currently positioned, before the communication terminal moves to the destination network; and
a communication information transmission unit for transmitting currently communicated communication information to the destination network control device;
wherein the bandwidth reservation control unit repetitively makes bandwidth reservation with a bandwidth to be reserved gradually lowered until reservation of a bandwidth succeeds.

26. The network control device according to claim 25, comprising a user needs storage unit for storing bandwidths set by a user as the user needs,
wherein the bandwidth reservation control unit repetitively makes bandwidth reservation with a bandwidth gradually lowered within the range of a bandwidth read out from the user needs storage unit.

27. A network control device for controlling communication connection of a communication terminal that is capable of connecting to a plurality of networks that use different communication schemes, comprising:
a movement prediction information reception unit for receiving movement prediction information that indicates a destination network that is predicted to be the destination of the communication terminal currently performing communication, from the communication terminal;
a bandwidth reservation control unit for reserving a bandwidth between a destination network control device that controls communication connection in the destination network indicated in the movement prediction information and the network control device for the network in which the communication terminal is currently positioned, before the communication terminal moves to the destination network; and
a communication information transmission unit for transmitting currently communicated communication information to the destination network control device;
wherein the bandwidth reservation request transmission unit transmits a bandwidth reservation request for reserving a bandwidth that is higher than the reserved bandwidth after a bandwidth reservation succeeds.
